(19) United States
(12) Patent Application Publication
(10) Pub. No.: US 2014/0153832 A1
(43) Pub. Date: Jun. 5, 2014

(54) FACIAL EXPRESSION EDITING IN IMAGES BASED ON COLLECTIONS OF IMAGES

(71) Applicants: Vivek Kwatra, Santa Clara, CA (US); Rajvi Shah, Gujarat (IN)

(72) Inventors: Vivek Kwatra, Santa Clara, CA (US); Rajvi Shah, Gujarat (IN)

(21) Appl. No.: 13/693,701

(22) Filed: Dec. 4, 2012

(51) Int. Cl. G06K 9/00

(52) U.S. Cl. CPC G06K 9/00281
USPC 382/195

(57) ABSTRACT

Implementations disclose editing of facial expressions and other attributes based on collections of images. In some implementations, a method includes receiving an indication of one or more desired facial attributes for a face depicted in a target image. The method searches stored data associated with a plurality of different source images depicting the face and finds one or more matching facial attributes in the stored data that match the one or more desired facial attributes. The matching facial attributes are associated with one or more portions of the source images. One or more target image portions in the target image are replaced with the one or more portions of the source images associated with the matching facial attributes.

### BACKGROUND

The popularity and convenience of digital cameras as well as the widespread of use of Internet communications have caused user-produced images such as photographs to become ubiquitous. For example, users of Internet platforms and services such as email, bulletin boards, forums, and social networking services post images for themselves and others to see and can accumulate collections of photos. Many captured images of a person, however, are undesirable to that person. For example, the user may not like his or her facial expression as captured in a photo, such as a solemn expression rather than a smiling one. Or, the depiction of the user may have his or her eyes closed in the photo, and the user would like the eyes to be open. In other examples, the user may desire that he or she did not have some other facial feature in a photograph.

### SUMMARY

Implementations of the present application relate to editing facial expressions and other facial attributes in an image based on collections of images. In some implementations, a method includes receiving an indication of one or more desired facial attributes for a face depicted in a target image. The method searches stored data associated with a plurality of different source images depicting the face and finds one or more matching facial attributes in the stored data that match the one or more desired facial attributes. The matching facial attributes are associated with one or more portions of the source images. The method replaces one or more target image portions in the target image with the one or more portions of the source images associated with the matching facial attributes.

Various implementations and examples of the above method are described. The facial attributes can include an angry facial expression, a happy facial expression, a sad facial expression, a presence of facial hair, a state of eyes, and/or a presence of glasses, for example. Pre-processing can be performed to create the stored data, and can include determining source facial attributes for a face of a particular person depicted in each of the different source images, and storing the stored data including mappings of the source facial attributes to face image portions of the particular person in the different source images. The mappings can include a hash table that maps possible facial attributes to the source facial attributes of the associated portions of the source images. The stored data can include a plurality of source facial attributes for each of the source images and a score for each of the source facial attributes, where a score is determined for each of the desired attributes which is compared to the scores of the source facial attributes. Each score for each source facial attribute can indicates a confidence that the face in the associated source image depicts the source facial attribute associated with the score, and/or can indicate a degree that the face in the associated source image depicts the source facial attribute associated with the score.

Finding the one or more matching facial attributes can include finding a plurality of best matching facial attributes, and can further comprise determining a compatibility to the target image of each portion of the source images associated with the best matching facial attributes, and selecting the portions of the source images having the highest compatibility. Determining the compatibility can include checking for similarity between brightness of the target image and each portion of the source images associated with the best matching facial attributes, and/or for similarity between a facial position depicted in the target image and in each portion of the source images associated with the best matching facial attributes. The one or more matching facial attributes can be associated with portions of a plurality of different source images.

In some implementations, replacing target image portions in the target image can include replacing the face depicted in the target image with a face depicted in a single one of the source images, where the single source image is associated with the best matching facial attributes. In some implementations, replacing target image portions can include replacing different portions of the target image face with portions from different source images. Replacing target image portions can include determining one or more face region masks based on locations of detected facial features in faces depicted in the one or more matching source images. For example, the face region masks can include a mask constructed as a convex polygon that is fit to include landmark points marking at least one of the detected facial features in each of the matching source images, where a source image portion within the mask is stitched into the target image to replace a corresponding portion of the target image.

In some implementations, receiving an indication of one or more desired facial attributes for the face depicted in the target image can include receiving input from a user in a graphical interface indicating the one or more desired facial attributes. In some implementations, the received input from the user can include movement of one or more graphical controls indicating the one or more desired attributes, and/or lines drawn on the target image and recognized as one or more of the desired attributes.

A method can include, in some implementations, determining a plurality of source facial attributes for a face of a particular person depicted in each of a plurality of different source images. The method stores mappings of the source facial attributes to portions of the source images that correspond to portions of the face of the particular person depicted in the source images. The method receives an indication of one or more desired facial attributes for a face of the particular person depicted in a target image, where the desired facial attributes are different than one or more existing facial attributes depicted in the target image. The method searches the mappings, finds one or more matching source facial attributes that match the one or more desired facial attributes, and obtains matching portions of the source images mapped to the matching source facial attributes. One or more target image portions in the target image are replaced with the matching portions of the source images.

In some implementations, a system can include a storage device and at least one processor accessing the storage device and operative to perform operations. The operations include receiving an indication of one or more desired facial attributes for a face depicted in a target image. The operations include searching stored data associated with a plurality of different source images depicting the face and finding one or more matching facial attributes in the stored data that match the one or more desired facial attributes, where the one or more matching facial attributes are associated with one or more portions of the source image. The system replaces one or more target image portions in the target image with the one or more portions of the source images associated with the one or more matching facial attributes.

In various implementations and examples of the above system, operations can further include performing pre-processing to create the stored data, including determining a plurality of source facial attributes for a face of a particular person depicted in each of the different source images, and storing the stored data including mappings of the source facial attributes to face image portions of the particular person in the different source images. The stored data can include a plurality of source facial attributes for each of the source images and a score for each of the source facial attributes, and the operations can include determining a score for each of the one or more desired attributes which is compared to the scores of the source facial attributes.

### BRIEF DESCRIPTION OF THE DRAWINGS

FIG. 1 is a block diagram of an example network environment which may be used for one or more implementations described herein;

FIG. 2 is a flow diagram illustrating an example of a method of editing facial attributes in an image based on a collection of images, according to some implementations;

FIGS. 3A, 3B, and 3C are illustrations of examples of simplified graphical user interfaces allowing a user to select desired facial attributes for a target image, according to some implementations;

FIG. 4 is a flow diagram illustrating example implementations for pre-processing stored data from source images for facial attributes;

FIG. 5 is a flow diagram illustrating example implementations of replacing one or more target image portions with one or more best matching source image portions;

FIGS. 6A, 6B, and 6C are examples of source, target, and resulting composite images used in an implementation of the method of FIG. 5;

FIGS. 7A, 7B, and 7C are diagrammatic illustrations of example masks used in stitching a source image portion onto a target image, according to some implementations; and

FIG. 8 is a block diagram of an example device which may be used for one or more implementations described herein.

### DETAILED DESCRIPTION

One or more implementations described herein relate to editing and modifying facial expressions or other facial attributes in a target image based on a collection of images. In some implementations, a system can pre-process a collection of source images to find and score various facial attributes of faces depicted in those source images. Such facial attributes can include facial expressions (happy, sad, angry, etc.) or other facial features (e.g., eyes open or closed, or presence of sunglasses, facial hair, etc.). At run-time, a user indicates desired changes to existing facial attributes of one or more faces depicted in a target image. The system can find facial attributes from the source images that match the desired attributes, and stitch source facial image portions into the target image to create the facial depiction desired by the user. Disclosed features allow a system to quickly perform changes to facial expressions in images as desired by a user, and without the user having to manually find appropriate replacement attributes and edit the images.

In some examples, the system can perform the pre-processing on a photo album or other collection that includes multiple source images depicting the face of the same person. The pre-processing can include analyzing the source images to find facial attributes depicted in the source images. The system can map the source facial attributes to face image portions in the source images. For example, the system can store the facial attributes as indices in a data structure that maps to the image portions, such as a hash table allowing fast lookup. In some examples, the system can determine a score for each of the facial attributes. Each score can indicate whether that facial attribute is depicted in the associated face image portion of a source image, and/or can indicate the degree of that facial attribute as depicted in the associated face image portion (e.g., mildly angry or very angry). Some implementations can determine attributes and scores applying to an entire face in a source image, while other implementations can provide an attribute and score for each individual facial feature in a source image, such as for eyes, nose, and lips of a face.

During run-time operation, a target image is provided to the system as well as one or more desired facial attributes for a face depicted in the target image. Some systems can provide a graphical user interface allowing a user to graphically select the desired facial attributes. For example, the user can select to change the facial attributes in the target image from a neutral expression to a happy expression, with eyes open, and having a beard. The system searches stored data of that same person's face derived from the source images, to find source facial attributes that match the desired attributes. For example, the searched data can be the pre-processed data structure described above. The system finds source facial attributes that match the desired facial attributes and obtains the associated face image portions from the source images. In one example, the system assigns scores to the user's desired facial attributes and compares those scores with scores of the source facial attributes stored in the data structure, to find the closest matching source image portions. In some implementations, the system can find a single face image portion that matches all the desired attributes. In other implementations, the system can find multiple face image portions, each face image portion matching one of the desired attributes. In some implementations, the system can also perform a compatibility check to find the best matching source image portions having the best compatibility with the corresponding target image portions to be replaced, such as having a similar brightness, similar facial pose, etc.

The system then replaces one or more target image portions with the matched face image portions from the source images. In some implementations, the entire face in the target image is replaced with a selected face from a source image. In other implementations, individual facial features in the target image can be replaced by corresponding individual features from one or more source images. For example, if a desired facial attribute is a happy expression, then a smiling mouth and eyes from the source images can be stitched in place of the original eyes and mouth in the target image. The individual image portions can be from one source image, or from different source images. Further processing and blending can smooth out any edges or transitions between original and replacement image portions in the resulting composite image.

Such features allow a user to perform editing of facial attributes in images while providing realistic and natural results. A system can quickly look up facial attributes from other images of the user that match desired attributes, and perform changes to facial expressions in images as desired by a user. Described features enable easier and quicker modification of facial attributes of faces depicted in images.

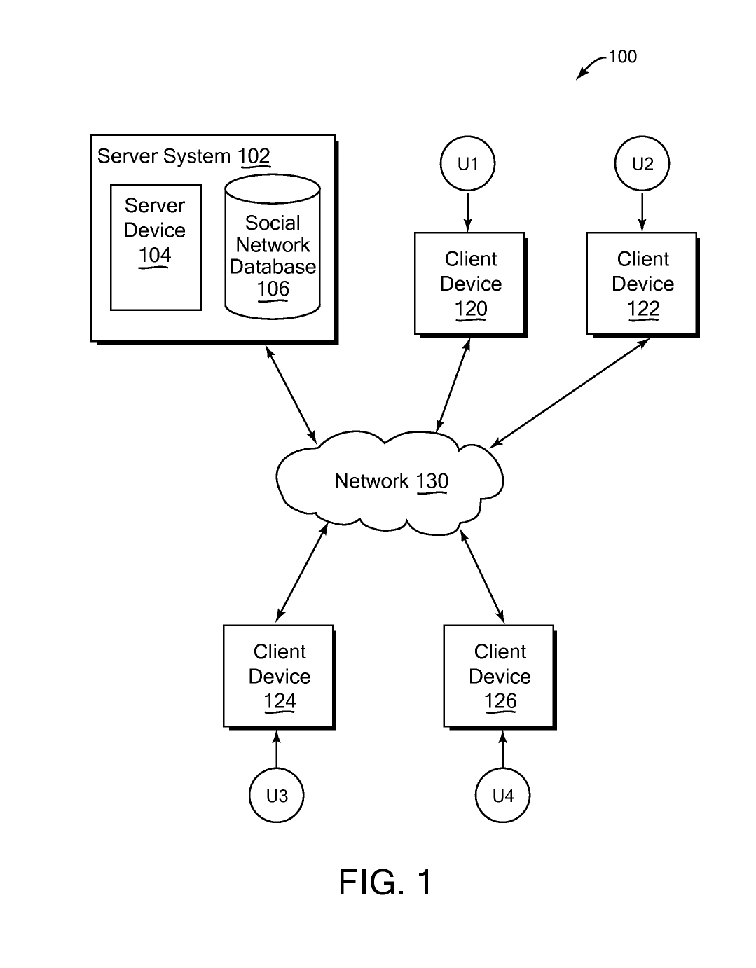

FIG. 1 illustrates a block diagram of an example network environment 100, which may be used in some implementations described herein. In some implementations, network environment 100 includes one or more server systems, such as server system 102 in the example of FIG. 1. Server system 102 can communicate with a network 130, for example. Server system 102 can include a server device 104 and a social network database 106 or other storage device. Network environment 100 also can include one or more client devices, such as client devices 120, 122, 124, and 126, which may communicate with each other via network 130 and server system 102. Network 130 can be any type of communication network, including one or more of the Internet, local area networks (LAN), wireless networks, switch or hub connections, etc.

For ease of illustration, FIG. 1 shows one block for server system 102, server device 104, and social network database 106, and shows four blocks for client devices 120, 122, 124, and 126. Server blocks 102, 104, and 106 may represent multiple systems, server devices, and network databases, and the blocks can be provided in different configurations than shown. For example, server system 102 can represent multiple server systems that can communicate with other server systems via the network 130. In another example, social network database 106 and/or other storage devices can be provided in server system block(s) that are separate from server device 104 and can communicate with server device 104 and other server systems via network 130. Also, there may be any number of client devices. Each client device can be any type of electronic device, such as a computer system, portable device, cell phone, smart phone, tablet computer, television, TV set top box or entertainment device, personal digital assistant (PDA), media player, game device, etc. In other implementations, network environment 100 may not have all of the components shown and/or may have other elements including other types of elements instead of, or in addition to, those described herein.

In various implementations, users U1, U2, U3, and U4 may communicate with each other using respective client devices 120, 122, 124, and 126, and in some implementations each user can receive messages and notifications via a social network service implemented by network system 100. In one example, users U1, U2, U3, and U4 may interact with each other via the social network service, where respective client devices 120, 122, 124, and 126 transmit communications and data to one or more server systems such as system 102, and the server system 102 provides appropriate data to the client devices such that each client device can receive shared content uploaded to the social network service via server system 102.

The social network service can include any system allowing users to perform a variety of communications, form links and associations, upload and post shared content, and/or perform other socially-related functions. For example, the social network service can allow a user to send messages to particular or multiple other users, form social links in the form of associations to other users within the social network system, group other users in user lists, friends lists, or other user groups, post or send content including text, images (such as photos), video sequences, audio sequences or recordings, or other types of content for access by designated sets of users of the social network service, send multimedia information and other information to other users of the social network service, participate in live video, audio, and/or text chat with other users of the service, etc. A user can organize one or more albums of posted content, including images or other types of content. A user can designate one or more user groups to allow users in the designated user groups to access or receive content and other information associated with the user on the social networking service. As used herein, the term “social networking service” can include a software and/or hardware system that facilitates user interactions, and can include a service implemented on a network system. In some implementations, a “user” can include one or more programs or virtual entities, as well as persons that interface with the system or network.

A social networking interface, including display of content and communications, privacy settings, notifications, and other features described herein, can be displayed using software on the client device, such as application software or client software in communication with the server system. The interface can be displayed on an output device of the client device, such as a display screen. For example, in some implementations the interface can be displayed using a particular standardized format, such as in a web browser or other application as a web page provided in Hypertext Markup Language (HTML), Java™, JavaScript, Extensible Markup Language (XML), Extensible Stylesheet Language Transformation (XSLT), and/or other format.

Other implementations can use other forms of devices, systems and services instead of the social networking systems and services described above. For example, users accessing any type of computer network or network/storage service can make use of features described herein. Some implementations can provide features described herein on systems such as one or more computer systems or electronic devices that are disconnected from and/or intermittently connected to computer networks.

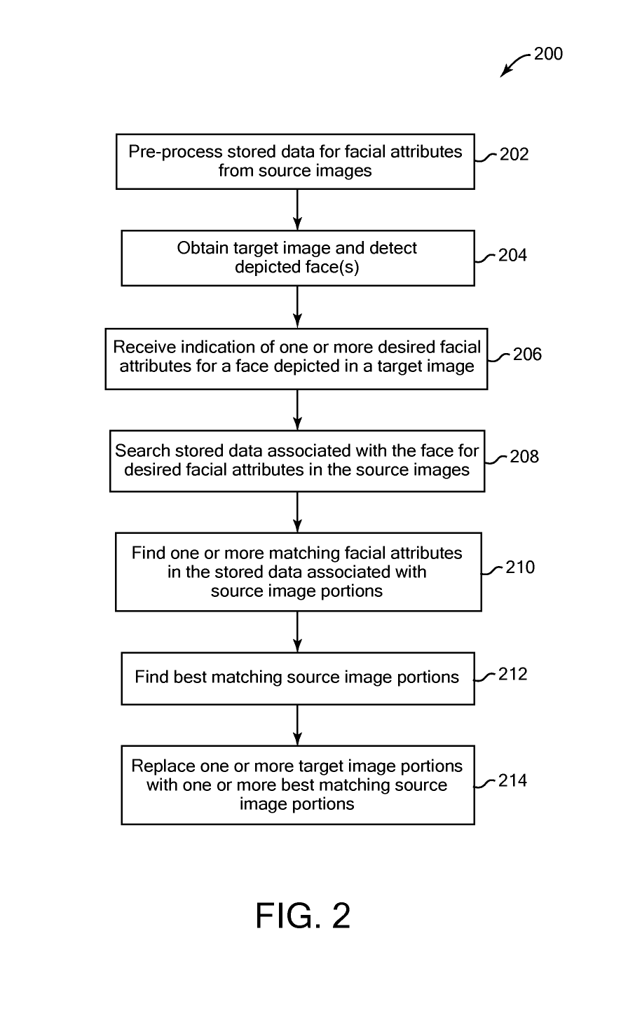

FIG. 2 is a flow diagram illustrating one example of a method 200 of editing facial attributes in an image based on a collection of images. Method 200 can be implemented on a computer system, such as one or more client devices and/or server systems, e.g., a system as shown in FIG. 1 in some implementations. In described examples, the system includes one or more processors or processing circuitry, and one or more storage devices such as a database 106 and/or other storage device. In some implementations, different components of a device or different devices can perform different blocks or other parts of the method 200. Method 200 can be implemented by program instructions or code, which can be implemented by one or more processors, such as microprocessors or other processing circuitry and can be stored on a computer readable medium, such as a magnetic, optical, electromagnetic, or semiconductor storage medium, including semiconductor or solid state memory, magnetic tape, a removable computer diskette, a random access memory (RAM), a read-only memory (ROM), flash memory, a rigid magnetic disk, an optical disk, a solid-state memory drive, etc. Alternatively, these methods can be implemented in hardware (logic gates, etc.), or in a combination of hardware and software. The method 200 can be performed as part of or component of an application running on a server or client device, or as a separate application or software running in conjunction with other applications and operating system.

In some implementations, all or part of method 200 can be initiated by the input from a user. A user may, for example, have selected the initiation of blocks 204-214 from an interface such as a social networking interface or other graphical interface. In some implementations, all or part of method 200 can be initiated automatically by a system and performed based on known user preferences. In some examples, the system can scan for images in stored image collections, or perform all or part of method 200 based on a particular event such as one or more images being newly uploaded to or accessible by the system, or based on a condition occurring as specified in custom preferences of one or more users.

In block 202 of method 200, the method pre-processes stored data from source images for facial attributes. The pre-processing block 202 can be performed, for example, before a target image is to have facial attributes modified as in blocks 204-214. The source images can be any images accessible to the method. In some implementations, the source images can be digital images composed of multiple pixels, for example, and can be stored on one or more storage devices of the system, or otherwise accessible to the system. For example, the source images can be stored on a single storage device or across multiple storage devices. In some implementations, the source images can be collected in an album or other collection associated with one or more particular users of the system, such as an album provided in an account of a user of a social networking system. Further, some implementations can use images that are individual still photos, and/or source images from video data, e.g., individual video frames from one or more video sequences. In some implementations, the system can designate which multiple source images to use for pre-processing. For example, the system can scan content or albums of one or more users and examine, retrieve, and/or store one or more images of the content or albums as source images. In some implementations, the system can examine new images as source images, which can be images that have not been pre-processed by block 202 since the last time that block 202 was performed by the system. In some implementations, pre-processing block 202 can be performed at various times or performed in response to a particular event, such as one or more images being newly uploaded to or accessible by the system, or a condition specified in custom preferences of one or more users.

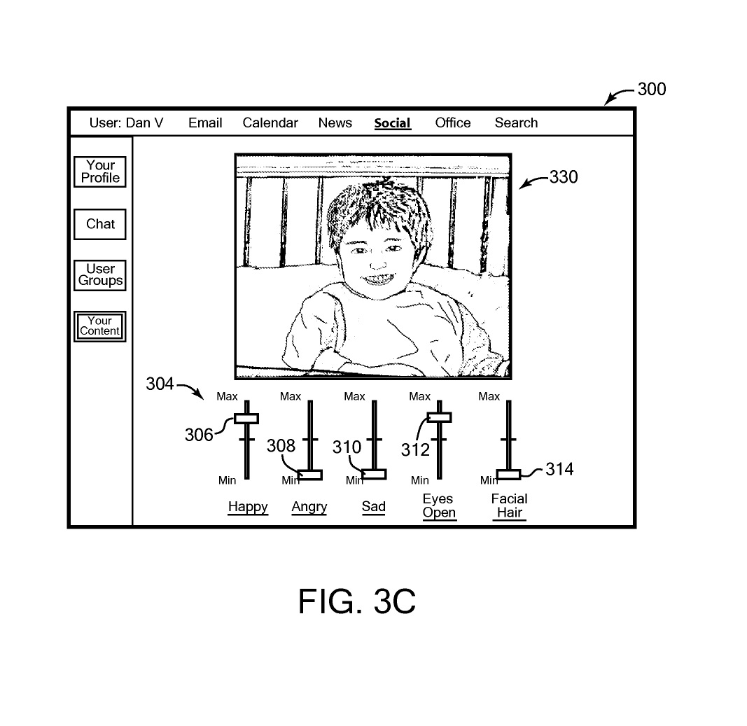

The pre-processed stored data can provide mappings of particular facial attributes to face portions of the source images which depict those facial attributes. The stored data can be organized into mappings for each person whose face is depicted in the source images, so that a particular set of mappings applies to a single person. In some implementations, facial attributes are detected in the source images and are scored based on the presence and/or degree of the attributes in each source image, and the scores can also be stored in the stored data. Some examples of pre-processing of the stored data from source images is described below in greater detail with respect to FIG. 4.

Blocks 204-214 can be performed at a later time and/or on a different system or the same system as the pre-processing in block 202. In block 204, the method obtains a target image and detects any depicted faces in the target image. In some implementations, the target image can be an image designated or selected by a user. For example, the target image can be newly uploaded to a server system from a client device by a user, and/or can be stored on a storage device accessible to the system. In some examples, the target image can be included in an album or other collection associated with a particular user of the system. In some implementations, the target image can be displayed in a graphical interface viewed by the user, while in other implementations the target image need not be displayed.

Some implementations can detect faces in the target image by recognizing the faces. To recognize the faces, the system can make use of any of a variety of techniques. For example, facial recognition techniques can be used to identify that a face of a person is depicted and/or can identify the identity of the depicted person. For example, in a social networking service, a recognized face can be compared to faces of users of the social networking service to identify which people depicted in images are also users of the service. Some images can be associated with identifications or identifiers such as tags that describe or identify people in the image, and these tags can be obtained as identifications of depicted content. In various implementations, the faces can be recognized by the method 200, or face detections can be obtained by receiving identifications determined by a different process or system. In some implementations, the same recognition techniques used to obtain face identifications for the preprocessing block 202 can also be used for identifying faces in the target image.

In some implementations, faces can be detected without identifying or recognizing the identities of the persons depicted. For example, it can be sufficient for the system to determine that one or more faces is depicted, and to compare characteristics of that face with other faces that have been pre-processed in block 202 to find a match to the same person without ever having identified the person's name or other identifying information. For example, some implementations can generate a signature from a particular face, e.g. from the graphical appearance of facial features. The signature can then be compared to other signatures generated from images pre-processed in block 202 to determine which pre-processed faces match the particular face from the target image.

In block 206, the method receives an indication of one or more facial attributes that are desired for a face depicted in the target image. The desired facial attributes are different than one or more existing facial attributes depicted in the target image. In some implementations, the face can be selected by the user, for example, if multiple faces are depicted in the target image. The desired facial attributes are indicated by a user to replace existing facial attributes in one or more portions of the target image. Some implementations can receive the desired facial attributes from user preferences or user settings in a graphical interface or an environment such as a social networking service. In some implementations, one or more of the desired facial attributes can be received based on selections made by a user using controls displayed in a graphical interface.

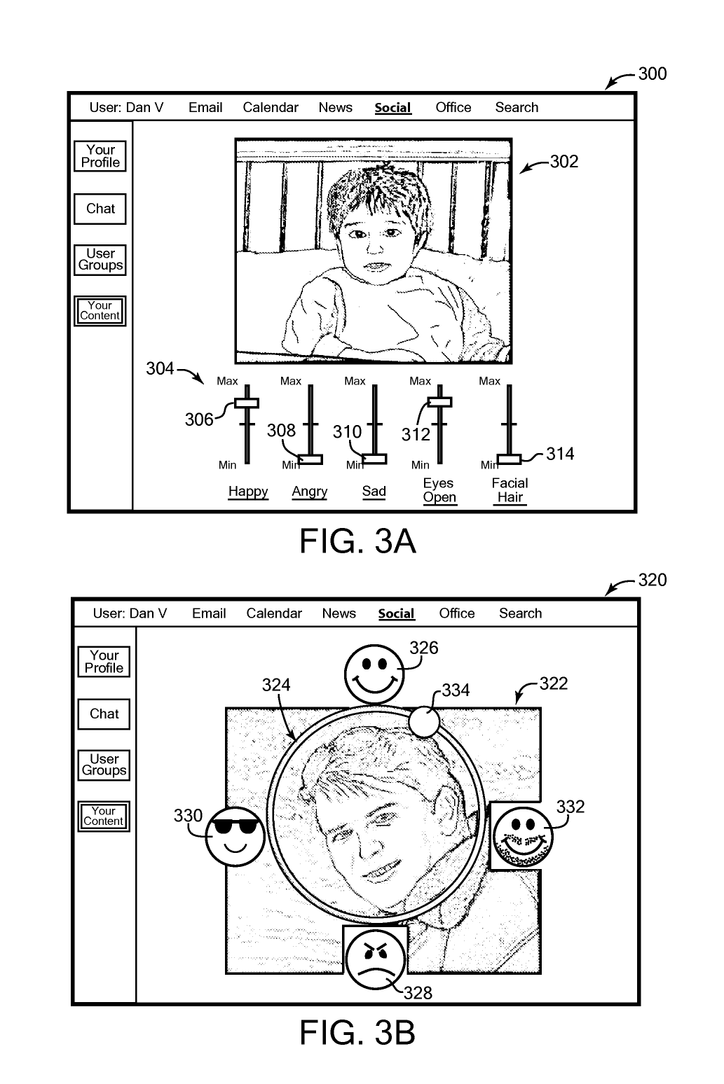

FIG. 3A is a diagrammatic illustration of one example of a simplified graphical user interface 300 allowing a user to select desired facial attributes for a target image. In this example, graphical user interface (GUI) 300 is displayed on a display device, e.g., of a client device 120, 122, 124, and/or 126 of FIG. 1, or a server system 102 in some implementations. In one example, a user can be viewing images on the interface 300 for use with a social networking service, or in an interface of an application running on the social networking service. In some examples, the user has uploaded a target image 302 to the social networking service and the user has selected the target image 302 for modification of facial attributes. Other implementations can display images using an application program, operating system, or other service or system, such as on a standalone computer system, portable device, or other electronic device. In the example of FIG. 3A, the target image 302 is a digital image, such as a digital photograph taken by a camera, and stored in an album of the user Dan V. Various images in collections such as albums, or spread among other collections and storage devices, can all be processed by one or more of the features described herein.

In the example of FIG. 3A, the target image 302 is displayed in the interface 300 along with a number of sliders 304 which allow the user to input desired facial attributes. Each slider can indicate a desired facial attribute, and in some implementations can allow the user to designate a degree of a particular facial attribute. In one example, sliders 304 can include a slider 306 for a happiness attribute, a slider 308 for an angry attribute, a slider 310 for a sad attribute, a slider 312 for eyes open/closed attribute, and a slider 314 for a facial hair attribute. In some implementations, each slider can have two positions, indicating whether or not the user wants the associated attribute in the target image. In other implementations, each slider can be continuously positioned within its movement range, allowing adjustment of the associated attribute from a minimal or zero level to a maximum level. Some sliders 304 can be active or inactive depending on the states of one or more other sliders. For example, if the happiness slider 306 is set above zero, then the angry and sad sliders 308 and 310 can be made inactive since they can be designated to be exclusive of the happiness attribute. In some implementations, the sliders presented as available to the user in the graphical interface 300 can be based on the source images available for the person whose face is selected for modification in the target image. For example, if none of the source images depict the person having a sad expression or facial hair, then no sliders 304 are displayed for the sad attribute and the facial hair attribute in the interface 300. Some implementations can check for the existence of facial attributes in the pre-processed data provided by block 202, for example.

FIG. 3B illustrates another example of a user interface 320 which can receive user input indicating one or more desired facial attributes for a target image. A target image 322 is displayed in interface 320. A circle 324 of attributes can be displayed around the image. In one example, if the user selects a face for modification in the target image, the circle 324 is displayed such that the selected face is positioned in or near the center of the circle. A number of facial attribute icons can be displayed at various positions around the circle, and one or more indicators can be moved by the user to indicate desired facial attributes for the target image. For example, in FIG. 3B, a happiness attribute icon 326 is displayed at a top of the circle 324, and an angry attribute icon 328 is displayed at the opposite, bottom of the circle 324. A sunglasses attribute icon 330 can be displayed at a left position of the circle 324, and a beard or facial hair attribute 332 can be displayed at the right side. An attribute indicator 334 can be moved along the circle 324 based on input from the user such that desired facial attributes corresponding to the nearest or surrounding icons are emphasized or weighted for the target image. For example, the current position of the indicator 334 is between the happiness attribute icon 326 and the facial hair attribute icon 332 on the circle 324, which indicates that the user has selected these surrounding attributes as the desired facial attributes, while the attributes associated with icons 328 and 330 are not selected. Thus, attributes at opposite positions of the circle cannot both be selected, which prevents the user from selecting both happiness and angry attributes in this example. The indicator 334 is closer to the happiness icon 326 than the facial hair icon 332, which in some implementations can indicate that the user wants to emphasize the happiness attribute more than the facial hair attribute in the desired modifications. If the indicator 334 were positioned directly at the happiness icon 326, then no facial hair attribute would be selected.

Other implementations can use different or altered interface features. For example, in some implementations the indicator 334 can also be moved into the middle of the circle 324 to select additional attributes close to the indicator, such as along a horizontal track connecting the sunglasses and facial hair attributes. One or more additional indicators 334 can be displayed to allow additional selections. If any selected attributes conflict (such as selecting both happiness and angry attributes), then some implementations can select one of these attributes that appears more preferred or selected by the user.

In some implementations, a graphical user interface can receive user input that forms a drawing or sketch indicating one or more desired facial attributes. For example, the user may input lines drawn using a user-controlled cursor, stylus, or finger on the selected face of the target image using an input device such as a pointing device (mouse, trackball, stylus, etc.) or touchscreen display of the system. The drawn lines can be interpreted by the method to indicate the desired attributes. In one example, a user can input lines forming a sketch of a smile over the mouth of a face desired to be modified. The method can examine the sketch symbolically or using handwriting recognition techniques to determine that the user wants a smile to be depicted in the selected face of the target image. Other lines, sketches, or symbols can be received from the user to indicate various attributes such as angry (e.g., lines over eyes, gritting teeth), sad (frown on mouth), facial hair (drawn on chin of face), glasses or sunglasses (drawn over eyes), tattoos (drawn on the face), etc.

Referring back to FIG. 2, after receiving indication of the desired facial attributes in block 206, in block 208 the method searches stored data associated with the selected face in the target image to find the desired facial attributes in the source images. For example, the stored data can be the pre-processed stored data from block 202 which identifies facial attributes in the source images and stores the attributes in a data structure allowing lookup and matching to desired facial portions of the source images for persons depicted in the source images. For example, the desired attributes can be matched to facial attributes in the data structure, which refer to the portions of the source images having those facial attributes.

In some implementations, the method searches the stored data by searching for scores associated with facial attributes in the stored data. For example, the method can determine scores for the desired facial attributes indicated by the user, and then search for matching scores in the stored data. Matching scores can be scores within a predetermined range of each other, in some implementations. When determining scores for the desired attributes selected by the user, the method can base the scores on values provided from user input, and these values can be converted to a scale used for the scores of the stored data. For example, if a user selects a desired smile attribute close to the maximum degree allowed, the system can convert this indication into a value, such as 0.9 on a scale of 0 to 1, where 0 is no smile and 1 is the maximum degree of smile. In an embodiment having an interface similar to that shown for FIG. 3B, in which the weights of two different attributes can be indicated, the system can look at the position of the indicator and convert the position into a value in a predetermined scale. For example, if the indicator is at a position ¼ of the distance away from the smile attribute on the section of the circle 324 between smile and facial hair attributes, then a value of 0.75 can be assigned for the smile attribute and 0.25 for the facial hair attribute on a scale of score values from 0 to 1.

In some implementations, the method can determine scores for the existing facial attributes of the selected face in the target image in its current state, and can then determine desired facial attribute scores based on user input and relative to the existing target image scores. The method can determine the existing facial attributes using the same techniques used in block 202 to detect facial attributes in the source images. For example, the method can determine that the existing target image face does not have any smile (e.g., a score of 0 in a scale of 0 to 1), or can determine that the target image face has a minor smile (e.g., a score of 0.3 in a scale of 0 to 1). If the user has provided an indication of desiring a greater smile attribute for this face, then the method can search for facial attributes in the stored data that have a smile attribute greater than the determined score for the target image, or search for a smile attribute that is greater than the target image score by at least a predetermined amount or threshold amount, such as searching for a score that is at least 0.3 greater than the existing target attribute score.

After the desired facial attribute scores are determined, the system can compare these values to the score values of facial attributes stored in the stored data for faces of the same person who was recognized or identified in block 204 in the target image. In some implementations, the source images are pre-processed to provide facial attributes for all the faces depicted in the source images, and the known set of facial attributes are provided with scores indicating the amount that each of those facial attributes exists in each associated source image. The scores for the desired attributes for the target image are compared with these scores for the source image facial attributes. The particular person whose facial attributes are being searched in the stored data can be identified using facial recognition on the target image, by determining a signature from the selected face in the target image, etc.

In block 210, the method finds one or more matching facial attributes in the stored data which are associated with source image portions that depict the associated facial attributes. In some implementations, the matching facial attributes have scores that match (e.g., exactly match or are within a predetermined range of) the scores of the desired facial attributes. In some cases, multiple matching facial attributes are found for source image portions from different source images. For example, three different source images may depict a smile that matches a desired smile facial attribute.

In some implementations, the method can search for a match to a face portion using a combination of multiple desired facial attributes. For example, using the data structure described above, the method can look for matches to multiple facial attributes that are all depicted in a single face portion of a source image. In some implementations, the method can find one or more source image faces that match a combination score of the desired attributes within a threshold distance. In one example, the user may have indicated a desired smiling attribute score of 1 and a desired eyes-open attribute score of 1, which are combined as a total score of 2. The method can search for a source image face portion that has both smiling and eyes-open attributes close to 1. In one example, the method finds a first face portion having a smile attribute of 0.9 and an eyes-open attribute of 0.8, which provides a total score of 1.7 which has a distance of 0.3 from the desired total score of 2. A second face portion is found having a smile attribute of 1 and an eyes-open attribute of 0.2, providing a total of 1.2 and a distance of 0.8 from the desired total score. If, for example, the threshold matching distance is 0.5 or less, then the first face portion would be considered a match and the second face portion is not a match. In some implementations that rank matches or try to find the best matches, the first face portion may be considered to be a better match, since the total distance to the desired total score is less than for the second face portion. Some implementations can define the combination scores and/or distances differently than in this example. Furthermore, some implementations can weight the scores for different attributes differently in the total score, depending on whether the pertinent facial attributes are considered (by a particular user, or in general) to be less or more important or desirable. For example, the smiling attribute may be weighted greater in the total score than other attributes if that is a important facial attribute to the user.

In block 212, the method finds the one or more best matching source image portions from the source image portions found to match the desired facial attributes in block 214. In some implementations, this can include determining an overall compatibility score for the matching source image portions found in block 210. The overall compatibility score can reflect the suitability of a source image portion based not only on the depicted expression or other facial attribute, but also on factors such as how well the lighting in the source image portion matches the lighting in the corresponding target image portion that is to be replaced, and/or how well the pose of the face or face portion in the source image portion matches the facial pose in the corresponding target image portion (e.g., a face may be turned too much to the side). In some cases, for example, a source image face that may have a well-matched facial attribute may not be well-matched in lighting and/or in pose, and so a different source image face with less-matching attributes but better matches in lighting and/or pose may be selected as the best match.

In some implementations, a single face from the source images that has all the desired facial attributes can be selected as the best match. In other implementations, multiple faces from the source images can be selected as the best matches, where each selected face has the best match for a single particular desired facial attribute. Some implementations can provide multiple faces as best matches, where each face has a best matching particular facial feature such as eyes, mouth, etc.

In block 214, the method replaces one or more target image portions with the best matching source image portion(s) determined in block 212. In some implementations or cases, the entire selected face depicted in the target image is replaced with a source image portion that also depicts an entire face and is provided from a single source image. For example, in such a case the source image portion may have been the best matching portion to the desired attributes as determined in blocks 208-212. Some implementations can replace one or more target image portions with source image portions from multiple different source images. For example, a first source image portion can depict the eyes of the user in a first source image that best matches the eyes for the desired facial attributes, and a second source image portion can depict the mouth of the user in a second source image that best matches the mouth for the desired facial attributes.

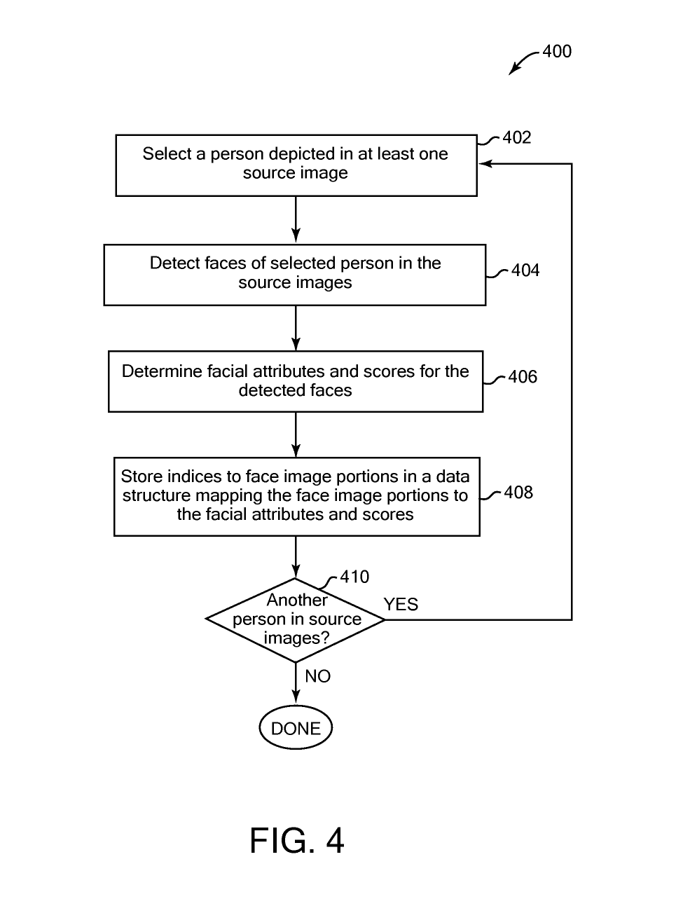

Any of a variety of different techniques can be used to replace the target image portion(s) with the corresponding source image portion(s), e.g., “stitch” the source image portion(s) into the target image. Some example implementations are described below with reference to FIG. 5. Other implementations can also be used. One example of a composite image 330 displayed in the user interface 300 is shown in FIG. 3C. The composite image 330 results from target image 302 in FIG. 3A, where a target image portion has been replaced by a source image portion of the depicted person's face having the desired facial attributes as specified in the graphical interface 300.

After the best matching source image portions have replaced the corresponding target image portions in the target image, the method is complete. In some implementations, the method 200 can be performed again in one or more additional iterations. For example, the user may restart the method from the beginning to input different desired facial attributes to apply to an unmodified (original) target image, or may restart the method to further modify a modified target image. For example, in some implementations, the method 200 can check for user input as to whether the final modified target image is acceptable to the user. If the user inputs indicates that it is not acceptable, another iteration of method 200 can be performed for the original, unmodified target image or for the modified target image.

FIG. 4 is a flow diagram illustrating a method 400 describing example implementations for block 202 of method 200 of FIG. 2, in which stored data is pre-processed from source images for facial attributes. Method 400 can be implemented on one or more systems similarly as described above for method 200 of FIG. 2. Some or all of method 400 can be performed on a different system than the system(s) performing blocks 204-214 of method 200, or on the same system(s).

In block 402, the method selects a person depicted in at least one source image. For example, if multiple persons are depicted in the source images, then one of those persons can be selected for processing for facial attributes. As described with reference to FIG. 2, the source images can be any set of images, such as user albums or other collections in some examples.

In block 404, the method detects faces and facial attributes of the selected person in the source images. Similarly as described above in block 204 for face detection in the target image, face detection for the source images can use facial recognition techniques to identify faces and/or identifications of persons belonging to detected faces. Other implementations can detect that different faces in the source images belong to different persons, but need not identify the persons with name or other identification information. Some implementations can generate a signature for a person's face based on facial features.

In block 406, the method determines facial attributes from the faces detected in block 402 and can determine scores for the determined facial attributes. In some implementations, for each face of the selected person detected in the source images, an analysis can be performed on the face to determine which facial attributes exist for that face. Such facial attributes can include expressions such as happy, sad, or angry, and can also include other attributes such as eye status (open or closed), facial hair, glasses or sunglasses, tattoos, or other attributes. The method can examine an entire face to determine whether an attribute exists in a face, or can examine particular facial features or portions, such as the eyes, mouth, cheeks, etc.

In some implementations, a score is provided for facial attributes associated with each detected face depicted in the source images. For example, a predetermined set of facial attributes can be associated with each detected face, and each facial attribute in the set can be associated with a score indicating whether the attribute exists or not in the associated face, and/or providing other information related to the attribute in that face. For example, in some implementations the score can be a binary score that indicates whether or not the associated attribute is present in the face. In other implementations, the score can take on any value within a particular range, where the value can indicate other information. For example, in some implementations the value can indicate a confidence in detecting the correct facial attribute in the face. In some implementations, the value can indicate the degree or amount of that facial attribute in the face.

For example, some implementations can make use of supervised learning or machine learning techniques, such as using classifiers to detect facial attributes in detected faces. In one example, multiple classifiers are used, where each classifier can detect the presence of one of the predetermined facial attributes. Each classifier can be previously trained (on the same system or different system) to recognize its associated facial attribute. For example, such training can include providing the classifier with several training images known to have the associated facial attribute for which that classifier is being trained. In some examples, such training images may have been evaluated to have the associated facial attribute by users or other persons, search results, and/or other methods. For each received training image, the classifier can determine the facial attributes by using facial recognition techniques, including segmenting facial features and/or examining particular characteristics. By receiving training images known to depict a particular facial attribute, the classifier can learn to look for the particular characteristics common to its associated facial attribute and distinguish that facial attribute from other facial attributes. Thus, training images can be fed to the classifier to provide a profile of results which the classifier expects to see if an input image depicts a face having the associated facial attribute for that classifier. For example, in some implementations, hundreds or thousands of training images may have been used to train the classifier.

The detected faces in the source images can be input to the trained classifiers. The classifiers can each output a score indicating the presence of its associated facial attribute in each source image. For example, the classifier output can be a binary value indicating whether or not the facial attribute is present. In some embodiments, the output can be a value indicating the confidence of the classifier that its associated facial attribute is present in a face. For example, the closer that a face in a source image is to the trained attribute of the classifier, the more confident it can be that the facial attribute exists in the source image face. Each resulting score can be calibrated to a desired scale. For example, some implementations can use a calibrated scale of 0 to 1, where 0 indicates that the attribute is not present and 1 indicates the attribute is present.

In some implementations, the score can be a continuous score that can take on any value within a continuous range, and where the score value indicates a degree or magnitude of the facial attribute in the detected face of the source image. For example, if using a calibrated score range of 0 to 1, a score of 0.4 or 0.5 can indicate that the facial attribute is somewhat depicted but not as present or obvious as an attribute having a score value of 1. Continuous scores can be determined in some implementations by using classifiers that have been trained with ranks or degrees of their associated facial attribute in different faces. For example, training images can include ranking information indicating that one particular training image is ranked as having a less degree of the attribute than another training image (e.g., training images ranked previously by operators, users, etc.). The classifier can use this ranking data to determine a score in a continuous value range. In some implementations, the classifier's score can be fit to a mapping function, such as a lookup table, that maps the score to a calibrated score range. Some implementations can provide a continuous score that indicates both confidence and a degree of attribute, e.g., the lower the degree, the less confident is the classifier that the associated facial attribute is depicted.

In some example implementations, boosted classifiers can be trained for a set of facial attributes. For example, a classifier can be trained for a smile attribute and another classifier for an eyes-open attribute. In one example, an image search of a large set of images (e.g., such as an image search on the world wide web or other internet space) can return a large set of images to train the classifiers. Manual annotations (e.g., by operators) can be made as to whether the faces in the training images are smiling or not smiling, and whether the faces have eyes open or closed. The classifiers can be trained with these training images to detect facial features. For example, a classifier can use a pyramidal histogram of oriented gradients, including features that encode a local shape in the image and a spatial layout of the shape at various scales. The local shape can be captured by a histogram of orientation gradients within a spatial window, and the spatial layout can be captured by gridding the image into regions at multiple resolutions. A final feature vector can be a concatenation of orientation histograms for the spatial windows at used grid resolutions. For the eye-state classifier, the feature extraction can be limited to the eye region of the face. For the smile classifier, features can be extracted from the mouth and the entire face since a smile may cause subtle changes in cheek and eye muscles as well as the mouth. The orientation angles can be quantized into bins for histogram computation, which gives a multi-dimensional feature vector for a single spatial window. For example, for eye-state, features can be extracted for two pyramid levels. For smile detection, features can be extracted for three pyramid levels.

Furthermore, rectangular (Haar-like) features can be extracted from certain regions for eye-closure and certain regions for smile detection. These features encode average intensity difference of adjacent rectangular regions. For example, three regions can be used for eye-closure, such as one region for each eye and a region encompassing both eyes; and six regions can be used for a mouth, in a grid encompassing the mouth. In addition, pyramidal histograms of color features can be used, since the difference in teeth/lips color and iris/skin color can be used to detect eyes and mouth features. These features of pyramidal histograms of oriented gradients, rectangular features, and pyramidal histograms of color features can be combined into a high dimensional feature vector for use with a learning process of a classifier. In one example, a learning process such as an AdaBoost learning algorithm can be used. The trained classifiers can return a score that is thresholded for the classification task. To provide a continuous score that ranks multiple faces of a person relative to a particular attribute, calibration can be used to convert the raw scores into membership probabilities. This can be performed by using logistic regression over the raw scores. For example, the classifiers can be calibrated to return a continuous score between 0 and 1.

For each determined facial attribute in the source images, the method can store a reference to the source image portion that is associated with that facial attribute. In many cases, for example, the referenced source image portion depicts the particular face associated with the determined facial attribute. For example, the reference can be a bounding box or other designated border in the source image that surrounds the associated face in the source image. In one example, a source image that depicts multiple faces can have a set of facial attributes for each of those faces.

In block 408, the method stores indices in a data structure, where the indices map a given facial attribute to the determined facial attributes and scores of a particular person as found in the source images. This data structure can allow the method to quickly search for the facial attributes of a person in the source images, and once a particular facial attribute is found, the associated face portions in source images are referenced and can easily be retrieved. In one example, the data structure can be a hash table. For example, the hash table can map each possible attribute score value (e.g., in a predetermined scale as described above) to an entry in the table that includes a list of one or more source image face portions that have that facial attribute with that score, or have an attribute close to that score (within a predetermined range). For example, the range of scores for an attribute can be divided into a number of bins or buckets of the hash table, and the facial attribute scores and associated source portions can be placed or referred to in the appropriate buckets. In one example, overlapping buckets can be used such that an attribute score of a source portion may be considered to be in both the buckets on either side of a particular bucket boundary, thus allowing more matches to be found.

In block 410, the method checks whether another person is depicted in the source images whose face images have not yet been processed by method 400. If there is at least one more such person, then the method returns to block 402 to select a depicted person for image processing. If there are no such faces left to process, the process is complete.

FIG. 5 is a flow diagram illustrating a method 500 describing example implementations for block 214 of method 200 of FIG. 2, in which one or more target image portions are replaced with one or more best matching source image portions. Method 500 can be implemented on one or more systems similarly as described above for method 200 of FIG. 2.

In block 502, the method selects a matched source image portion from one or more best matching source image portions as determined in previous blocks. In some implementations, the selected source image portion can be an entire face portion of a source image, while in other implementations the selected source image portion can be a portion of a face, such as eyes or a mouth feature. In block 504, the method aligns the selected source portion with the corresponding target image portion in the target image. This block can include resizing the source image portion such that the facial feature(s) depicted in the source image portion will correspond to the size of the facial features in the corresponding target image portion, as well as aligning the orientation of the source image portion to the corresponding target image portion.

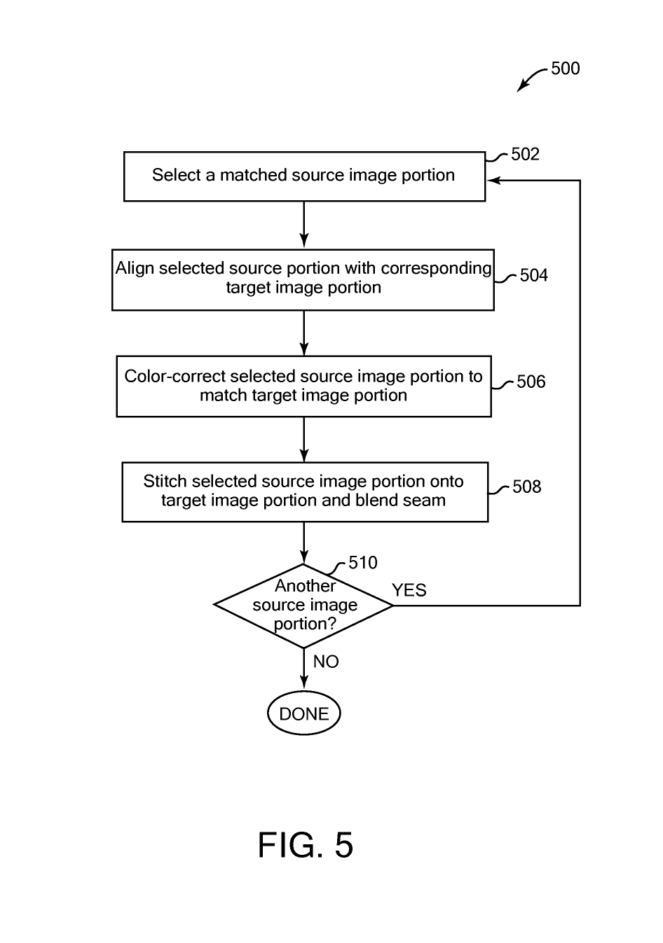

FIG. 6A illustrates one example of a source image 600 including a source image portion 602, which in this example is a face portion here shown within a bounding box. Landmark feature points 604 for the face portion 602 have been detected, e.g. in the pre-processing block 202 or at some other stage in the method 200, which mark locations such as eyes, center of nose, corners of the mouth, etc. FIG. 6B illustrates an example of a target image 610, where the target image includes a target image portion to be replaced by the source image portion 602, such as an area 612 approximately shown in FIG. 6B. The source image 600 has been resized and re-oriented to approximately align the landmark feature points 604 with corresponding landmark feature points 614 found in the target image portion 612.

Referring back to FIG. 5, in block 506 the method color-corrects the selected source image portion to match the color of the target image portion that is being replaced. Such color correction can compensate for illumination variation between the source and target images. In one example, the color correction can include adjusting a color channel in the source image by adding the mean value of a color channel in the target image and subtracting the mean value of that color channel in the source image. For example, the source image can corrected as shown in equation (1):

I_{S}^{C}←I_{S}^{C}+Īₜ^{C}−Ī_{S}^{C} (1)

In Equation (1), Ī^{C} refers to the mean value of color channel c in image I, and subscripts s and t correspond to source and target, respectively.

In block 508, the method stitches the selected source image portion onto the corresponding target image portion and blends the seam of the image portions to remove any noticeable transitions. In some implementations, masks such as a source region opacity mask and a target region opacity mask can be used to in the process of stitching a portion of the source image into the target image. The source and target masks can allow certain pixels of the source and target images to be copied directly, while pixel areas between the masks are blended to provide better integration. Blending of any seam between the source and target image portions can also be performed.

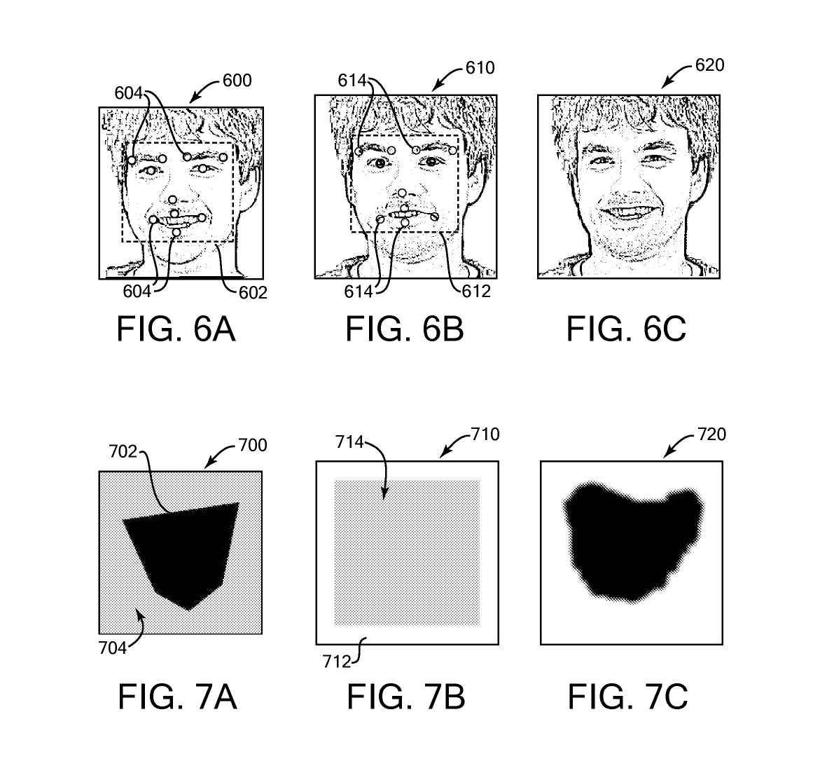

FIG. 7A is a diagrammatic illustration of a source opacity mask 700 that can be used for the face portion 602 in the source image 600 shown in FIG. 6A. In this example, the face portion from the source image 600 is desired to be stitched into the target image 620. Mask 700 has been created to include a convex polygon that has been fit on the source image face in the source image 600 to include all the landmark feature points 604 of the face. The pixels within the polygon 702 of mask 700, indicated by the filled-in black region, are constrained pixels that originate from the source image 600 and will be directly copied to a resulting composite image. In the gray region 704 surrounding the black polygon, it is unknown as yet which pixels will come from the source image and which from the target image, and so these pixels are unconstrained. In other cases or implementations, a portion or feature of a face can be stitched from a source image into the target image, where a source mask can be similarly created to include just the landmark feature points of the facial feature desired to be stitched, e.g., just the eyes of a face, a mouth, etc.

FIG. 7B is a diagrammatic illustration of a target opacity mask 710 that can be used on the face in the target image 610 shown in FIG. 6B. In this example, the border region 712 of the target image includes pixels constrained to originate from the target image 610 and be directly copied to the resulting composite image, shown as a white region. In the gray region 714 within the mask region 712, it unknown as yet which pixels will come from the source image and which from the target image, and so these pixels are unconstrained.

Since the source image portion being copied onto the target image may create artifacts along the boundary of the source image portion, one or more techniques can be used to blend or blur the seam or transition between the source and target image portions. A variety of different techniques can be used. In some implementations, for example, graph-cut optimization can provide “seamless” image portion replacement. Graph-cut optimization finds a suitable seam passing through unconstrained pixels by minimizing the total transition cost from source to target pixels. In one example, a quadratic formulation can be used for this cost, as shown in Equation (2) below.

C_{pq}(s,t)|_{s≠t}=|Iₛ(p)−Iₜ(p)|²+|I_{S}(q)−Iₜ(q)|² (2)

In Equation (2), Cpq(s,t) represents the cost of transitioning from the source image at pixel p to the target image at pixel q. The graph-cut optimization can be performed on the source mask and target mask within the unconstrained pixel region between the constrained regions of the masks to determine a lowest-cost seam and resulting in a graph-cut binary mask. In other implementations, other techniques can be used instead of or in addition to graph-cut optimization to find a suitable low-cost seam between source and target image portions. For example, dynamic programming techniques can be used.

After the lowest-cost seam is determined using the graph-cut optimization in the unconstrained regions, a blending can be performed to blend the source and target image portions along the seam to obtain the final composite image. For example, in some implementations, alpha blending can be used. An a blending value can be obtained by blurring the graph-cut binary mask that resulted from performing graph cuts as explained above. The final composite can be expressed as in Equation (3), below.

I_{c}=α·Iₛ+(1−α)·Iₜ (3)

In Equation (3), the composite image Ic comprises the masked source image portion Is plus the target image It, as modified by the alpha (α) value. In other implementations, other types of blending can be alternately and/or additionally used, such as multiband blending or gradient-domain integration.

FIG. 7C is a diagrammatic illustration of one example of a blending mask 720 created from the source opacity mask 700 and the target opacity mask 710 and which can be used to create the final composite image. The black region corresponds to source image pixels and the surrounding white region corresponds to target image pixels. The blending mask 720 includes a soft weighting across the transition boundary between source and target image pixels as provided by the blending technique. FIG. 6C shows a composite image 620 resulting from the application of the blending mask 720.

Referring back to FIG. 5, the image resulting from the stitching of the selected source image portion into the target image produces a composite image for the user. In block 510, the method checks whether there is another source image portion to stitch into the target image. For example, if different portions of one or more source images are being used, then another source portion may still need to be stitched into the target image (e.g., a mouth portion, etc.). If so, the method returns to block 502 to select another matched source portion for stitching. If not, the method 500 is complete.

It should be noted that the blocks described in the methods described above can be performed in a different order than shown and/or simultaneously (partially or completely) with other blocks, where appropriate. In some implementations, blocks can occur multiple times, in a different order, and/or at different times in the methods. In some implementations, one or more of these methods can be implemented, for example, on a server, such as server system 102 as shown in FIG. 1. In some implementations, one or more client devices can perform one or more blocks instead of or in addition to a server system performing those blocks.

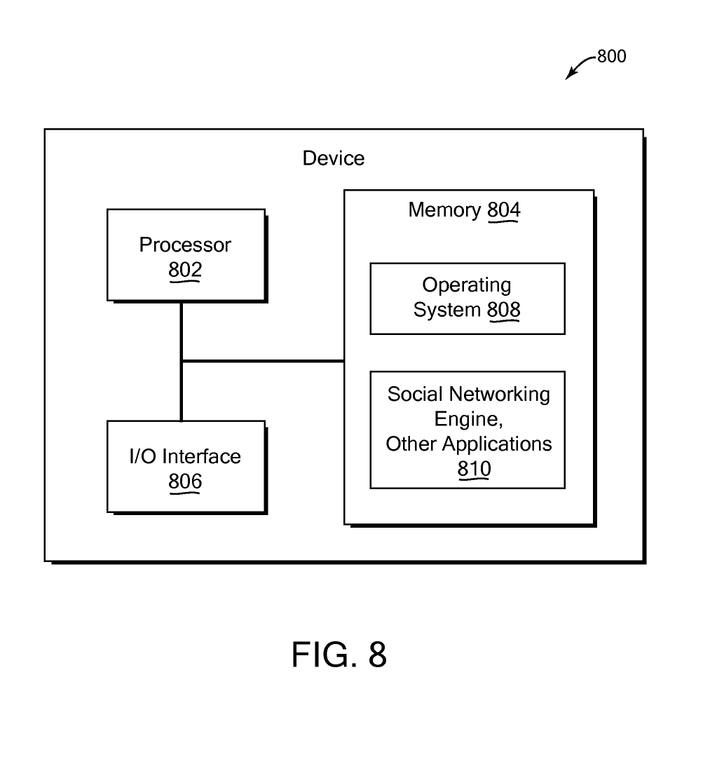

FIG. 8 is a block diagram of an example device 800 which may be used to implement some implementations described herein. In one example, device 800 may be used to implement server device 104 of FIG. 1, and perform appropriate method implementations described herein. Server device 800 can be any suitable computer system, server, or other electronic or hardware device. For example, the server device 800 can be a mainframe computer, desktop computer, workstation, portable computer, or electronic device (portable device, cell phone, smart phone, tablet computer, television, TV set top box, personal digital assistant (PDA), media player, game device, etc.). In some implementations, server device 800 includes a processor 802, a memory 804, and input/output (I/O) interface 806.

Processor 802 can be one or more processors or processing circuits to execute program code and control basic operations of the device 800. A “processor” includes any suitable hardware and/or software system, mechanism or component that processes data, signals or other information. A processor may include a system with a general-purpose central processing unit (CPU), multiple processing units, dedicated circuitry for achieving functionality, or other systems. Processing need not be limited to a particular geographic location, or have temporal limitations. For example, a processor may perform its functions in “real-time,” “offline,” in a “batch mode,” etc. Portions of processing may be performed at different times and at different locations, by different (or the same) processing systems. A computer may be any processor in communication with a memory.

Memory 804 is typically provided in device 800 for access by the processor 802, and may be any suitable processor-readable storage medium, such as random access memory (RAM), read-only memory (ROM), electrical erasable read-only memory (EEPROM), Flash memory, etc., suitable for storing instructions for execution by the processor, and located separate from processor 802 and/or integrated therewith. Memory 804 can store software operating on the server device 800 by the processor 802, including an operating system 808 and a social networking engine 810 (and/or other applications) in some implementations. In some implementations, the social networking engine 810 or other application engine can include instructions that enable processor 802 to perform the functions described herein, e.g., some or all of the methods of FIGS. 2, 4, and 5. Any of software in memory 804 can alternatively be stored on any other suitable storage location or computer-readable medium. In addition, memory 804 (and/or other connected storage device(s)) can store images, content, and other data used in the features described herein. Memory 804 and any other type of storage (magnetic disk, optical disk, magnetic tape, or other tangible media) can be considered “storage devices.”

I/O interface 806 can provide functions to enable interfacing the server device 800 with other systems and devices. For example, network communication devices, storage devices such as memory and/or database 106, and input/output devices can communicate via interface 806. In some implementations, the I/O interface can connect to interface devices such as input devices (keyboard, pointing device, touchscreen, microphone, camera, scanner, etc.) and output devices (display device, speaker devices, printer, motor, etc.).

For ease of illustration, FIG. 8 shows one block for each of processor 802, memory 804, I/O interface 806, and software blocks 808 and 810. These blocks may represent one or more processors or processing circuitries, operating systems, memories, I/O interfaces, applications, and/or software modules. In other implementations, server device 800 may not have all of the components shown and/or may have other elements including other types of elements instead of, or in addition to, those shown herein. While systems are described as performing blocks as described in some implementations herein, any suitable component or combination of components of a system, or any suitable processor or processors associated with such a system, may perform the blocks described.

A client device can also implement and/or be used with features described herein, such as any of client devices 120-126 shown in FIG. 1. Some example client devices are described with reference to FIG. 1 and can include some similar components as the device 800, such as processor(s) 802, memory 804, and I/O interface 806. An operating system, software and applications suitable for the client device can be provided in memory and used by the processor. The I/O interface for a client device can be connected to network communication devices, as well as to input and output devices such as a microphone for capturing sound, a camera for capturing images or video, audio speaker devices for outputting sound, a display device for outputting images or video, or other output devices. A display device, for example, can be used to display the settings, notifications, and permissions as described herein, where such device can include any suitable display device such as an LCD, LED, or plasma display screen, CRT, television, monitor, touchscreen, 3-D display screen, or other visual display device. Some implementations can provide an audio output device, such as voice output or synthesis that speaks text in ad/or describing the settings, notifications, and permissions.

Although the description has been described with respect to particular implementations thereof, these particular implementations are merely illustrative, and not restrictive. Concepts illustrated in the examples may be applied to other examples and implementations.

Note that the functional blocks, features, methods, devices, and systems described in the present disclosure may be integrated or divided into different combinations of systems, devices, and functional blocks as would be known to those skilled in the art. Any suitable programming language and programming techniques may be used to implement the routines of particular implementations. Different programming techniques may be employed such as procedural or object-oriented. The routines may execute on a single processing device or multiple processors. Although the steps, operations, or computations may be presented in a specific order, the order may be changed in different particular implementations. In some implementations, multiple steps or blocks shown as sequential in this specification may be performed at the same time.

What is claimed is:

1. A method comprising:
determining a plurality of source facial attributes for a face of a particular person depicted in each of a plurality of different source images;
storing mappings of the source facial attributes to portions of the source images that correspond to portions of the face of the particular person depicted in the source images;
receiving an indication of one or more desired facial attributes for a face of the particular person depicted in a target image, wherein the desired facial attributes are different than one or more existing facial attributes depicted in the target image;
searching the mappings and finding one or more matching source facial attributes that match the one or more desired facial attributes;
obtaining matching portions of the source images mapped to the matching source facial attributes; and
replacing one or more target image portions in the target image with the matching portions of the source images.

2. A method comprising:
receiving an indication of one or more desired facial attributes for a face depicted in a target image;
searching stored data associated with a plurality of different source images depicting the face and finding one or more matching facial attributes in the stored data that match the one or more desired facial attributes, wherein the one or more matching facial attributes are associated with one or more portions of the source images; and
replacing one or more target image portions in the target image with the one or more portions of the source images associated with the one or more matching facial attributes.

3. The method of claim 2 wherein the facial attributes include one or more of an angry facial expression, a happy facial expression, a sad facial expression, a presence of facial hair, a state of eyes, and a presence of glasses.

4. The method of claim 2 further comprising performing pre-processing to create the stored data, the pre-processing including:
determining a plurality of source facial attributes for a face of a particular person depicted in each of the plurality of different source images; and
storing the stored data including mappings of the source facial attributes to face image portions of the particular person in the different source images.

5. The method of claim 4 wherein the mappings include a hash table that maps possible facial attributes to the source facial attributes of the associated one or more portions of the source images.

6. The method of claim 2 wherein the stored data includes a plurality of source facial attributes for each of the source images and a score for each of the source facial attributes, and further comprising determining a score for each of the one or more desired attributes which is compared to the scores of the source facial attributes.

7. The method of claim 6 wherein each score for each source facial attribute indicates a confidence that the face in the associated source image depicts the source facial attribute associated with the score.

8. The method of claim 6 wherein each score for each source facial attribute indicates a degree that the face in the associated source image depicts the source facial attribute associated with the score.

9. The method of claim 2 wherein finding the one or more matching facial attributes includes finding a plurality of best matching facial attributes, and further comprising:
determining a compatibility to the target image of each portion of the source images associated with the best matching facial attributes; and
selecting the portions of the source images having the highest compatibility.

10. The method of claim 9 wherein determining the compatibility includes checking for at least one of:
similarity between brightness of the target image and each portion of the source images associated with the best matching facial attributes, and
similarity between a facial position depicted in the target image and in each portion of the source images associated with the best matching facial attributes.

11. The method of claim 2 wherein the one or more matching facial attributes are associated with portions of a plurality of different source images.

12. The method of claim 2 wherein replacing one or more target image portions in the target image includes replacing the face depicted in the target image with a face depicted in a single one of the source images, wherein the single source image is associated with the best matching facial attributes.

13. The method of claim 2 wherein replacing one or more target image portions in the target image includes replacing different portions of the face depicted in the target image with portions from different source images.

14. The method of claim 2 wherein replacing one or more target image portions includes determining one or more face region masks based on locations of detected facial features in faces depicted in the one or more matching source images.

15. The method of claim 14 wherein the one or more face region masks include a mask constructed as a convex polygon that is fit to include a plurality of landmark points marking at least one of the detected facial features in each of the one or more matching source images, wherein a source image portion within the mask is stitched into the target image to replace a corresponding portion of the target image.

16. The method of claim 2 wherein receiving an indication of one or more desired facial attributes for the face depicted in the target image includes receiving input from a user in a graphical interface indicating the one or more desired facial attributes.

17. The method of claim 16 wherein the input received from the user in the graphical interface includes at least one of:
movement of one or more graphical controls indicating the one or more desired attributes; and
lines drawn on the target image and recognized as the one or more desired attributes.

18. A system comprising:
a storage device; and
at least one processor accessing the storage device and operative to perform operations comprising:
receiving an indication of one or more desired facial attributes for a face depicted in a target image;
searching stored data associated with a plurality of different source images depicting the face and finding one or more matching facial attributes in the stored data that match the one or more desired facial attributes, wherein the one or more matching facial attributes are associated with one or more portions of the source images; and
replacing one or more target image portions in the target image with the one or more portions of the source images associated with the one or more matching facial attributes.

19. The system of claim 18 further comprising an operation of performing pre-processing to create the stored data, the pre-processing including:
determining a plurality of source facial attributes for a face of a particular person depicted in each of the plurality of different source images; and
storing the stored data including mappings of the source facial attributes to face image portions of the particular person in the different source images.

20. The system of claim 18 wherein the stored data includes a plurality of source facial attributes for each of the source images and a score for each of the source facial attributes, and further comprising an operation of determining a score for each of the one or more desired attributes which is compared to the scores of the source facial attributes.
